(19) United States
(12) Patent Application Publication
(10) Pub. No.: US 2008/0249488 A1
(43) Pub. Date: Oct. 9, 2008

(54) Portable waste receptacle with disposable bag

(76) Inventor: Sandra Quinones, Chicago, IL (US)

Correspondence Address: EUGENIO J. TORRES-OYOLA, Suite 403, 221 Ponce de Leon Ave., San Juan, PR, 00917, US

(21) Appl. No.: 11/732,585

(22) Filed: Apr. 3, 2007

(51) Int. Cl. A61J 19/00

(52) U.S. Cl. 604/317

(57) ABSTRACT

A portable apparatus for receiving human waste products having a first portable cylindrical member with a removable conical portion having a bowl shape connected to the upper open end of said first cylindrical member. The portable cylindrical member includes a second cylindrical member of a smaller diameter inside having a water-proof disposable and removable bag for receiving the human waste providing sanitary way of managing the body fluids.

### STATEMENT REGARDING FEDERALLY SPONSORED RESEARCH AND DEVELOPMENT

N/A

### RELATED APPLICATIONS

N/A

### BACKGROUND OF THE INVENTION

1. Field of the Invention

The present invention relates generally to a portable sanitary waste container for receiving body fluid such as vomit, and more particularly, to a container having a bowl-shape portion for guiding the body fluid to a removable and disposable bag for a sanitary way of managing the body fluid.

2. Discussion of the Background

Various portable devices such as disposable bags, pots, bowls and buckets are used for the collection and disposal of various body fluids such as vomit and saliva. The U.S. Pat. No. 4,990,145, for example, discloses a disposable bag having a funnel sealingly engaging a plastic bag and a cover or shroud sealingly attached to the outer surface of the funnel wherein the cover provides protection for the user from contact with contact with material which may miss the funnel during initial position thereof. Devices like this are use in hospitals, airplanes, homes, vehicles, ship and the alike. Usually the disposable bag is held by the user or in some cases by the person assisting the person vomiting. During vomiting the regurgitated substance is collected by the disposable bag however odors and/or contact with the vomit or vomit bag may cause nausea or spread the germs to the person assisting the person vomiting. Therefore a need to improve and provide a sanitary device capable of minimize the contact with the regurgitated substance and odors is needed.

### SUMMARY OF THE INVENTION

The portable waste receptacle is a portable container for receiving body fluids, in particular, vomit or saliva. The invention embodiment includes a first cylindrical member with a conical portion connected at an open end of said first cylindrical member. The conical portion provides a path for the body fluid in order to guide the regurgitated substance to a second cylindrical member which is located inside the first cylindrical member and has a disposable and removable bag for receiving the body fluids. The device has the advantage of stand by itself without the need of someone holding it, while protect the user from spillage.

Another object is to provide a portable waste receptacle that can be set by the bed and also be carried for a trip to the hospital with a sick relative.

Another object is to provide a sanitary way of discarding the waste material or to transport the content to laboratory.

Another object is to provide a chamber room which hold the regurgitated substance and minimize the odors and the spreading of germs.

The invention itself, both as to its configuration and its mode of operation will be best understood, and additional objects and advantages thereof will become apparent, by the following detailed description of a preferred embodiment taken in conjunction with the accompanying drawing.

When the word “invention” is used in this specification, the word “invention” includes “inventions”, that is, the plural of “invention”. By stating “invention”, the Applicant does not in any way admit that the present application does not include more the one patentable and non-obviously distinct invention and Applicant maintains that the present application may include more than one patentably and non-obviously distinct invention. The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

FIG. 1 is the isometric view of the first embodiment of the portable waste receptacle.

FIG. 2 is the isometric view with all the components of portable waste receptacle.

FIG. 3 is a view showing the principal elements of the portable waste receptacle.

FIG. 4a is the top view of the conical potion of the portable waste receptacle.

FIG. 4b is a side view of the conical potion of the portable waste receptacle.

FIG. 5a is the isometric view of the conical portion having ribs at the inner surface.

FIG. 5b is the isometric view of the conical portion having ribs at the inner surface.

FIG. 5c is the top view of the conical portion having protrusion with a seal and cap.

FIG. 6 is a perspective view of the second cylindrical member.

FIG. 7 is a side view of the second cylindrical member inserted in the first cylindrical member.

### DESCRIPTION OF THE PREFERRED EMBODIMENT

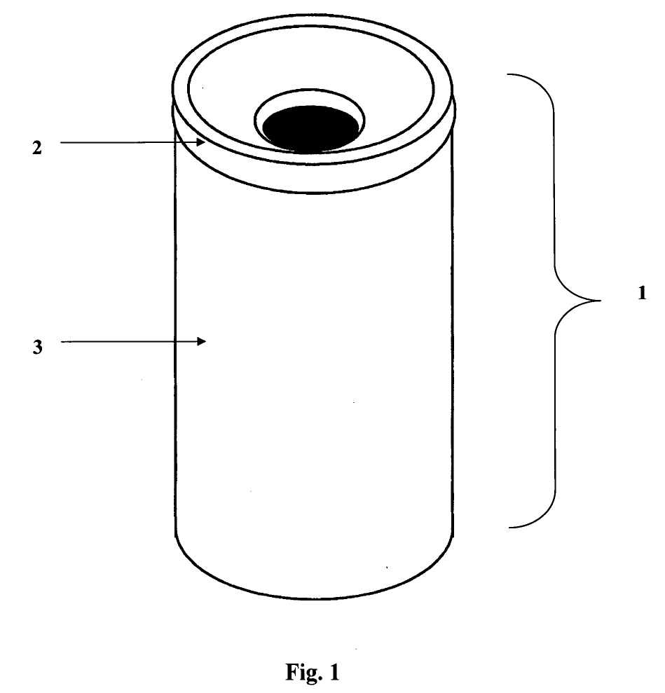

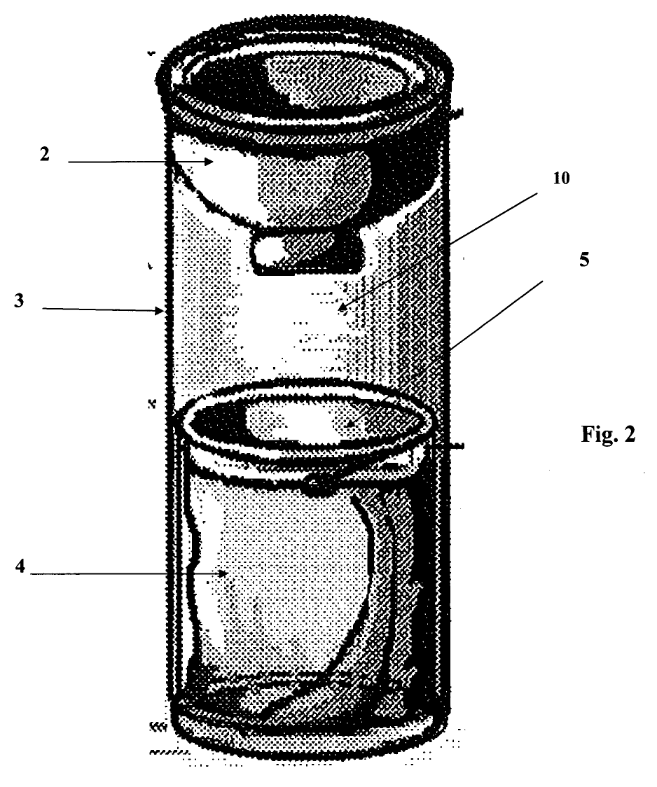

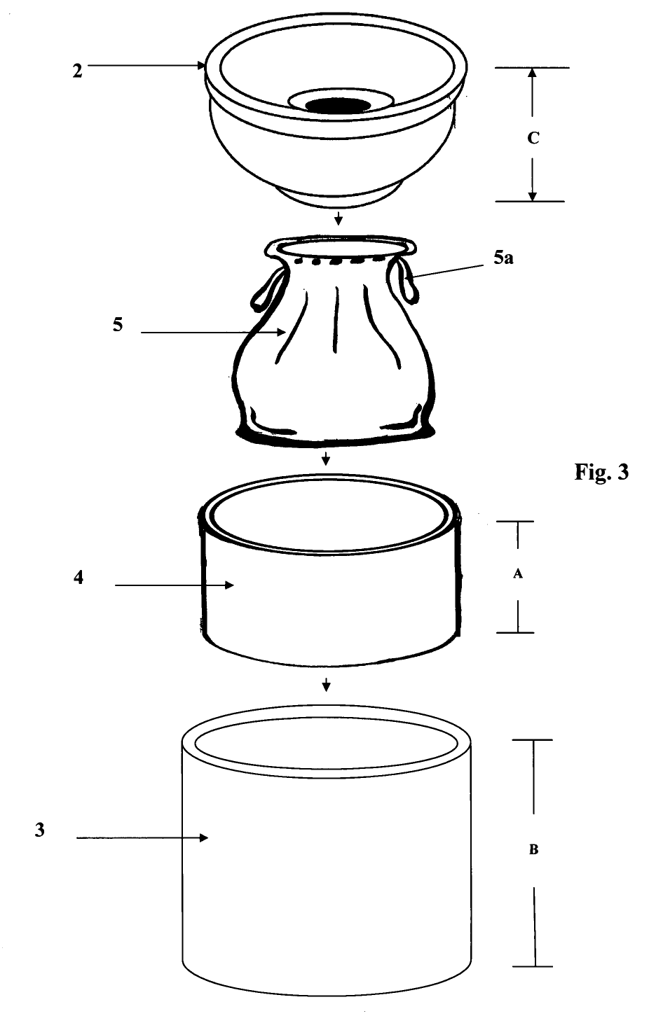

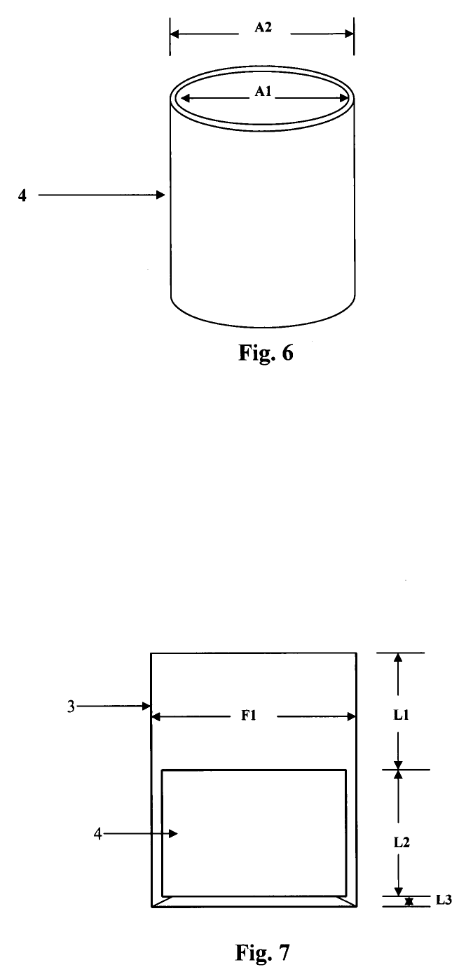

The present invention is a portable waste container 1, as show in FIG. 1, having a first cylindrical member 3 made of a water-proof washable material such as plastic with an open end wherein a conical portion 2 is connected by fixing means. Different means for the connection of the conical portion and the first cylindrical portion can be use, for example, screwing, clamping or any other method knows in the art. The connection is made in a sealing manner in order to minimize any regurgitated substance or odor to come out of the inner portion of the first cylindrical member 3. The first cylindrical member 3 has a diameter F1 of approximately 6.5 inches and a height B of approximately 12.5 inches, as show in FIG. 3 and FIG. 7. The conical portion is also made of a water-proof washable material.

Inside the first cylindrical member 3 is inserted a second cylindrical member 4. The second cylindrical member 4 of a height of 6 inches is made of the same material as the first cylindrical member 3 or any other water-proof washable material. It has a diameter A2 of approximately 6 inches or smaller than the diameter F1 of the first cylindrical member 3 and receives the waste material after passing through the conical portion 2. A removable and disposable bag 5 is positioned inside the second cylindrical member 4. The bag 5, as show in FIG. 3, is provided with strings 5a for an easy way to manage the waste material. The bag is made of plastic or any other impermeable elastic material capable to withstand the waste material inside.

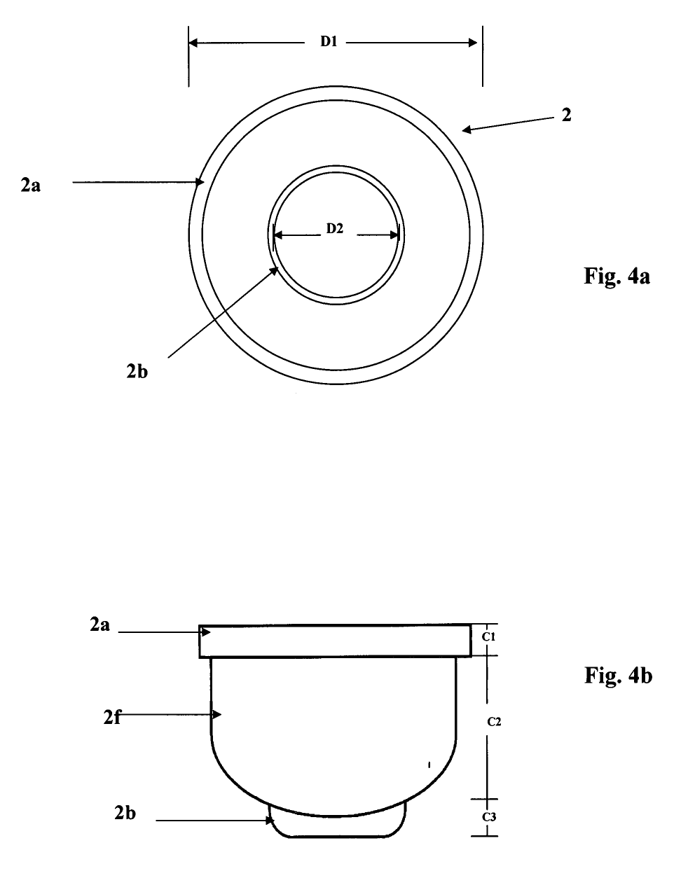

The body fluids are guide to the second cylindrical member 4 by a conical portion 2. The conical portion 2, as show in FIGS. 4a-4b, comprises a top portion 2a, a middle portion 2f and a protrusion 2b. The top portion 2a has a diameter D1 bigger than the first cylindrical portion open end in order to fit over the first cylindrical portion 3 and is the first part of the conical portion 2 to receive the body fluids. The top portion 2a is connected to the middle portion 2f having a bowl shape 2a with two different diameters. A middle portion 2f extends from the top portion 2a to the protrusion 2b. The middle portion diameter is approximately 6.5 inches, as the diameter of the first cylindrical portion 3, in order to fit inside the first cylindrical portion 3. The protrusion 2b has a cylindrical shape with a diameter of approximately 2.5 inches. The protrusion 2b is connected to the middle portion 2f and extends toward second cylindrical member 4. The protrusion 2b serves as a channel to guide the body fluids to the second cylindrical member 4. The total height of the conical portion is approximately 6 inches, wherein the top portion 2a is 1 inch, the middle portion 2f is 4 inches and the protrusion 2b is 1 inch.

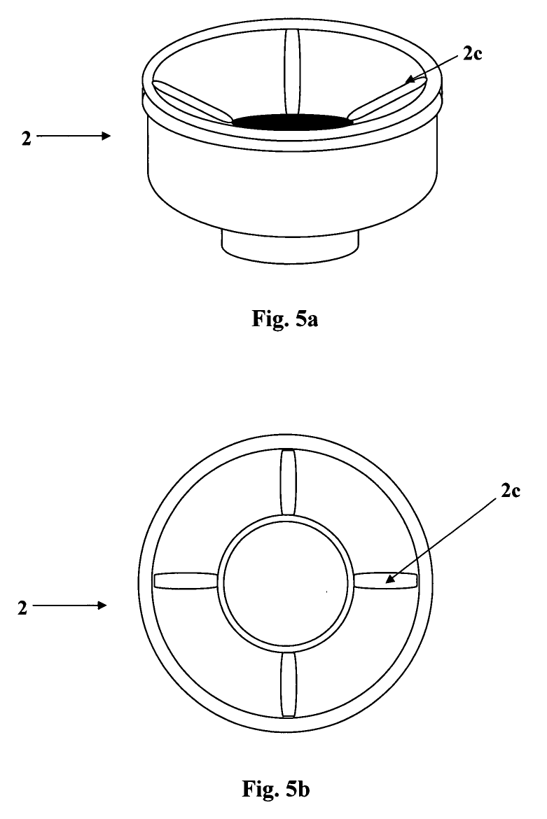

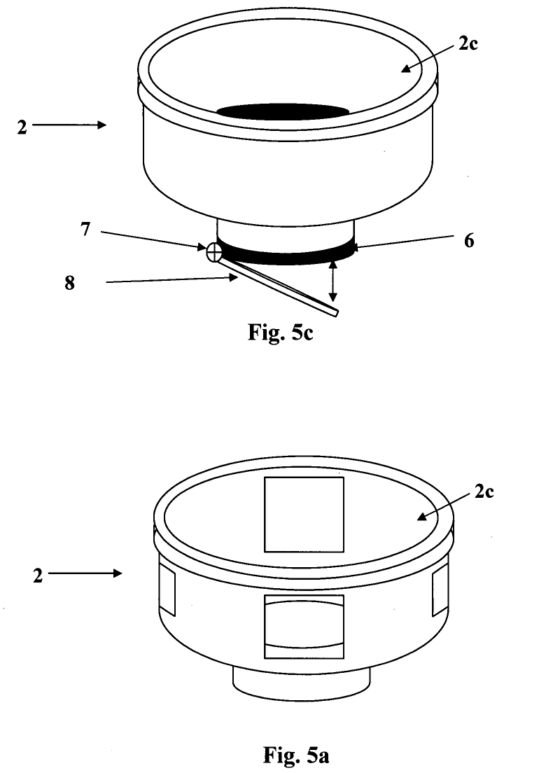

In order to minimize even more the odors from the coming out of the chamber 10 created by the first cylindrical portion 3 and the conical portion 2 a retractable cap 8 can be located at the open end of the protrusion 2b. The retractable cap move toward the second cylindrical member 4 while the body fluid is flowing from the middle portion 2f through the protrusion 2b and return to it original position after the flow of body fluids ends. A spring 7 is use to provide the back and forward motion of the cap, however any other element capable of having the same effect can be use. When the protrusion 2b is close, the cap 8 is in contact with a sealing ring 6 in order to seal the chamber 10 and minimize the body fluid odors coming out of the chamber 10. FIG. 5c shows a sealing ring 6, made of rubber or any other sealing material, positioned at the end of the protrusion 2b. Other improvements can be made to the conical portion 2, for example as show in FIG. 5a and FIG. 5b, ribs can be add to the inner surface of the middle portion 2b in order to improve the flow of the body fluids. Also, as show in FIG. 5d, the middle portion 2b can have holes in order to provide an easier path to the body fluids.

The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

1. An apparatus for receiving body fluids comprising:
a first cylindrical member having one open end;
a removable conical portion having a bowl-shape connected to said first cylindrical member open end by connecting means;
a removable second cylindrical member having one open end with a diameter smaller than the first cylindrical member, wherein said second cylindrical member is located inside the first cylindrical member and wherein the second cylindrical member open end is facing the conical portion.

2. An apparatus for receiving body fluids in accordance with claim 1 wherein:
a disposable and removable bag is inserted in the second cylindrical member for receiving the body fluids.

3. An apparatus for receiving body fluids in accordance with claim 2 wherein:
the disposable and removable bag is a liquid impermeable elastic string plastic bag.

4. An apparatus for receiving body fluids in accordance with claim 1 wherein:
the first and second cylindrical members are made of plastic or a water-proof material.

5. An apparatus for receiving body fluids in accordance with claim 1 wherein:
the first and second cylindrical members are made of a washable material.

6. An apparatus for receiving body fluids in accordance with claim 1 wherein:
the conical potion has a cylindrical protrusion extending toward the second cylindrical member for guiding the body fluids.

7. An apparatus for receiving body fluids in accordance with claim 6 wherein:
the protrusion extending toward the second cylindrical member has a seal and a retractable cap.

8. An apparatus for receiving body fluids in accordance with claim 1 wherein:
the conical portion has ribs at the inner surface of a middle portion of said conical portion.

9. An apparatus for receiving body fluids in accordance with claim 7 wherein:
the conical portion has holes at the inner surface of a middle portion of said conical portion.
